(19) United States
(12) Patent Application Publication
(10) Pub. No.: US 2026/0018362 A1
(43) Pub. Date: Jan. 15, 2026

(54) FIELD EMITTER AND METHOD FOR MANUFACTURING SAME

(71) Applicant: SUZHOU INSTITUTE OF NANO-TECH AND NANO-BIONICS (SINANO), CHINESE ACADEMY OF SCIENCES, Suzhou (CN)

(72) Inventors: Wenchao Shen, Suzhou (CN); Xiaodong Zhang, Suzhou (CN); Xing Wei, Suzhou (CN); Wenxin Tang, Suzhou (CN); Jiaan Zhou, Suzhou (CN); Baoshun Zhang, Suzhou (CN)

(21) Appl. No.: 18/995,253

(22) PCT Filed: Oct. 31, 2022
(86) PCT No.: PCT/CN2022/128615

§ 371 Date: Jan. 16, 2025

(30) Foreign Application Priority Data
Aug. 2, 2022 (CN) 202210921500.3

(51) Int. Cl. H01J 9/02; H01J 1/304; H01J 9/14

(52) U.S. Cl. CPC H01J 9/025; H01J 1/304; H01J 9/027; H01J 9/148; H01J 2201/30419; H01J 2201/30449; H01J 2209/012

(57) ABSTRACT

Disclosed is a method for manufacturing a field emitter, comprising: forming a primary epitaxial layer on a substrate; forming a plurality of secondary epitaxial structures on the primary epitaxial layer; forming an emitter electrode layer and a dielectric layer between the emitter electrode layer and the plurality of secondary epitaxial structures on the primary epitaxial layer; sequentially forming a protective layer, an insulating layer, a gate electrode layer and a planarization layer which are laminated on the dielectric layer and the plurality of secondary epitaxial structures; etching the planarization layer to expose part of the gate electrode layer on the dielectric layer and part of the secondary epitaxial structure; etching and removing the protective layer, the insulating layer and the exposed part of the gate electrode layer on part of the secondary epitaxial structure so as to expose part of the secondary epitaxial structure; forming a gate connection electrode layer on the exposed gate electrode layer on the dielectric layer; forming an anode opposite to the exposed part of the secondary epitaxial structure, the anode and the exposed part of the secondary epitaxial structure having a predetermined distance from each other. Further disclosed is a field emitter.

### TECHNICAL FIELD

The present disclosure belongs to the technical field of semiconductors and particularly relates to a field emitter and a method for manufacturing the same.

### BACKGROUND ART

Field emitters (FE) are vacuum transistors based on the field emission phenomenon and are suitable for use in harsh environments and high frequency electronic devices due to their radiation hardness and the absence of scattered electron transmission. Currently, silicon (Si)-based field emitters are the most developed. To reduce the operating voltage of FE, a sharp tip profile or a reduced spacing between a gate and an emitter is often required. Group III nitride semiconductor materials are considered to further enhance the performance of the FE and reduce the turn-on voltage because of their adjustable electron affinity (e.g., GaN can be doped with Al to control the Al component adjustment) and the case of n-type doping. Firstly, with the reduction of the electron affinity, electrons can more easily tunnel the semiconductor surface to be in the vacuum, which results in a lower operating voltage of the device.

At present, there is little research on the FE based on group III nitride, and the reported devices generally have turn-on voltages greater than 100 V; as the feature size of the FE is usually less than 100 nm, their preparation processes most rely on advanced photo-etching and etching techniques, such as electron beam photo-etching and wet digital etching techniques. The main problems are low current density, poor device stability, large preparation difficulties and poor on-chip uniformity.

### SUMMARY OF THE DISCLOSURE

In order to solve the above technical problems in the prior art, the present disclosure provides a field emitter and a method for manufacturing the same.

In one aspect, an embodiment of the present disclosure provides a method for manufacturing a field emitter, including: forming a primary epitaxial layer on a substrate; forming a plurality of secondary epitaxial structures on the primary epitaxial layer with a spacing between the adjacent secondary epitaxial structures; forming an emitter electrode layer and a dielectric layer between the emitter electrode layer and the plurality of secondary epitaxial structures on the primary epitaxial layer; sequentially forming a protective layer, an insulating layer, a gate electrode layer and a planarization layer which are laminated on the dielectric layer and the plurality of secondary epitaxial structures; etching the planarization layer to expose part of the gate electrode layer on the dielectric layer and part of the secondary epitaxial structure; etching and removing the protective layer, the insulating layer and the exposed part of the gate electrode layer on part of the secondary epitaxial structure so as to expose part of the secondary epitaxial structure; forming a gate connection electrode layer on the exposed gate electrode layer on the dielectric layer; forming an anode opposite to the exposed part of the secondary epitaxial structure, the anode and the exposed part of the secondary epitaxial structure having a predetermined distance from each other.

In one example of the manufacturing method provided in the above aspect, the plurality of secondary epitaxial structures are arranged in an array, the secondary epitaxial structure is a secondary epitaxial protruding block, and the secondary epitaxial rotruding block is in a shape of a circular truncated pyramid or a quadrilateral truncated pyramid.

In one example of the manufacturing method provided in the above aspect, the plurality of secondary epitaxial structures are sequentially arranged at intervals, the secondary epitaxial structure is a secondary epitaxial protruding rib, and the secondary epitaxial protruding rib extends in a length direction perpendicular to the direction in which the plurality of secondary epitaxial protruding ribs are arranged.

In one example of the manufacturing method provided in the above aspect, the predetermined distance is 1-10 mm.

In one example of the manufacturing method provided in the above aspect, before forming an emitter electrode layer and a dielectric layer between the emitter electrode layer and the plurality of secondary epitaxial structures on the primary epitaxial layer, the manufacturing method further includes: forming a depletion layer on the top surface and the side surface of the secondary epitaxial structure to form a depletion region between the side surface and the depletion layer.

In one example of the manufacturing method provided in the above aspect, before forming the primary epitaxial layer on the substrate, the manufacturing method further includes: forming a buffer layer on the substrate, the epitaxial layer being formed on the buffer layer.

In one example of the manufacturing method provided in the above aspect, the method for forming a plurality of secondary epitaxial structures on the primary epitaxial layer specifically includes: forming a mask layer on the primary epitaxial layer; patterning the mask layer to form a plurality of via holes distributed in an array in the mask layer; performing secondary epitaxy on the primary epitaxial layer exposed by each of the via holes to form a plurality of secondary epitaxial structures; and removing the remaining mask layer.

In one example of the manufacturing method provided in the above aspect, the method for forming a plurality of secondary epitaxial structures on the primary epitaxial layer specifically includes: forming a mask layer on the primary epitaxial layer; patterning the mask layer to form a plurality of via holes arranged sequentially at intervals in the mask layer, the via hole extending in a length direction perpendicular to the direction in which the plurality of via holes are arranged; performing secondary epitaxy on the primary epitaxial layer exposed by each of the via holes to form a plurality of secondary epitaxial structures; and removing the remaining mask layer.

In another aspect, the embodiment of the present disclosure provides a method for manufacturing a field emitter, including: sequentially forming a primary epitaxial layer and an aluminum oxide layer which are laminated on a substrate; patterning the aluminum oxide layer to form a plurality of via holes; forming a plurality of secondary epitaxial structures on the primary epitaxial layer exposed by the via hole; forming an emitter electrode layer and a dielectric layer between the emitter electrode layer and the plurality of secondary epitaxial structures on the primary epitaxial layer; sequentially forming an insulating layer, a gate electrode layer and a planarization layer which are laminated on the dielectric layer, the plurality of secondary epitaxial structures and the remaining aluminum oxide layer; etching the planarization layer to expose part of the gate electrode layer on the dielectric layer and part of the secondary epitaxial structure; etching and removing the insulating layer and the exposed part of the gate electrode layer on part of the secondary epitaxial structure so as to expose part of the secondary epitaxial structure; forming a gate connection electrode layer on the exposed gate electrode layer on the dielectric layer; forming an anode opposite to the exposed part of the secondary epitaxial structure, the anode and the exposed part of the secondary epitaxial structure having a predetermined distance from each other.

In still another aspect, the embodiment of the present disclosure provides a field emitter formed by the above manufacturing method.

Beneficial effects: the field emitter and the method for manufacturing the same of the present disclosure can provide device performance with a low turn-on voltage and a high gain. Since etching treatment is not required for forming the primary epitaxial layer and the secondary epitaxial structure which are directly formed by epitaxial deposition, the on-chip uniformity of the device is improved, the production efficiency of the device is improved and the reliability of the device is improved.

### DESCRIPTION OF THE DRAWINGS

The above and other aspects, features and advantages of the embodiment of the present disclosure will become more apparent from the following description when taken in conjunction with the accompanying drawings, in which:

FIG. 1A to FIG. 1H are views of the process of a method for manufacturing a field emitter according to an embodiment of the present disclosure;

FIG. 2A to FIG. 2D are views of the process for manufacturing and forming a secondary epitaxial structure according to an embodiment of the present disclosure;

FIG. 2E to FIG. 2H are views of the process for manufacturing and forming a secondary epitaxial structure according to another embodiment of the present disclosure;

FIG. 3 is a structural three-dimensional view of a secondary epitaxial structure according to an embodiment of the present disclosure;

FIG. 4 is a structural three-dimensional view of a secondary epitaxial structure according to another embodiment of the present disclosure; and

FIG. 5 is a schematic view of a depletion region according to an embodiment of the present disclosure.

### DETAILED DESCRIPTION

Embodiments of the present disclosure will be described in details below with reference to the accompanying drawings. The present disclosure may, however, be embodied in many different forms and should not be construed as limited to the embodiments set forth herein. Rather, these embodiments are provided to explain the principles of the present disclosure and its practical application to enable other persons skilled in the art to understand the various embodiments of the present disclosure and various modifications suitable for the particularly expected applications.

The terms “include” and variants thereof used in this text indicate open-ended terms, meaning “including but not limited to”. The term “based on”, “according to”, etc. indicate “at least partially based on” and “at least partially according to”. The terms “one embodiment” and “an embodiment” indicate “at least one embodiment”. The term “another embodiment” indicates “at least one additional embodiment”. The terms “first”, “second”, and the like may refer to different or identical objects. Other definitions, whether explicit or implicit, may be included below. The definition of one term is consistent throughout the description unless otherwise stated clearly in the context.

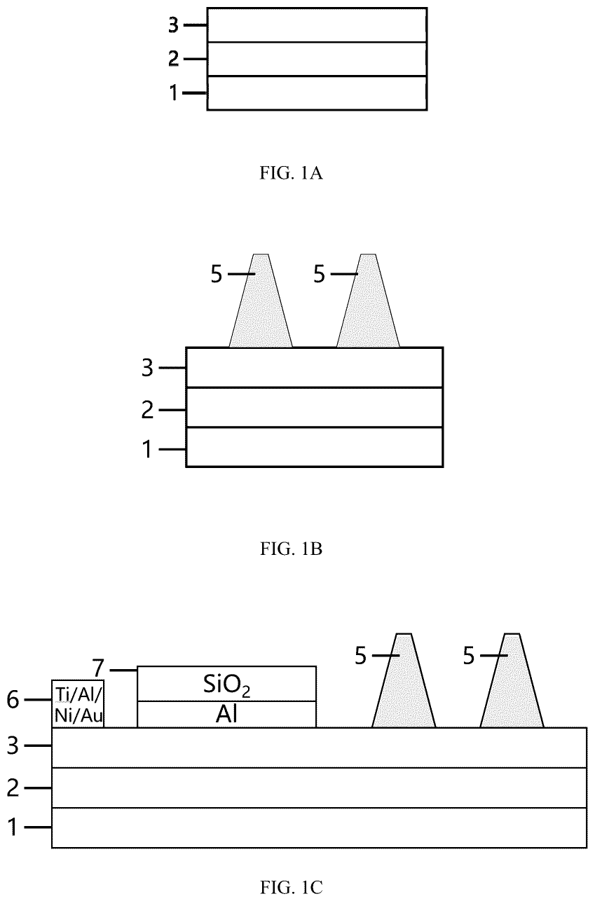

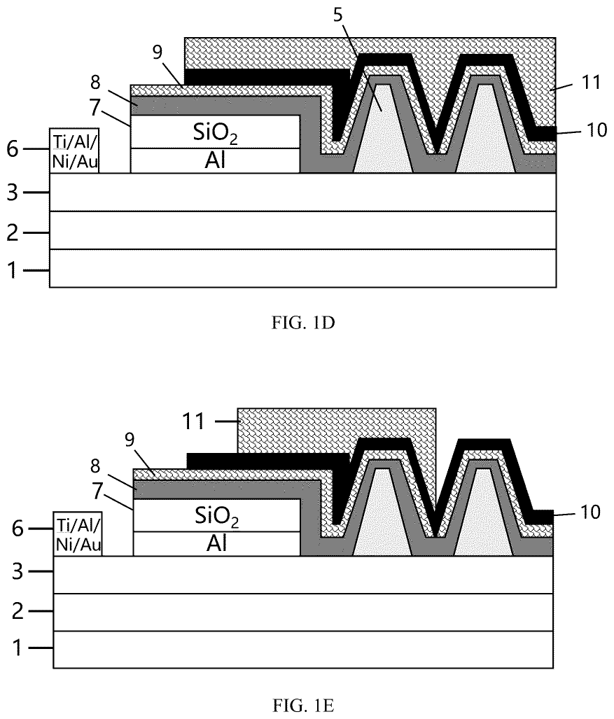

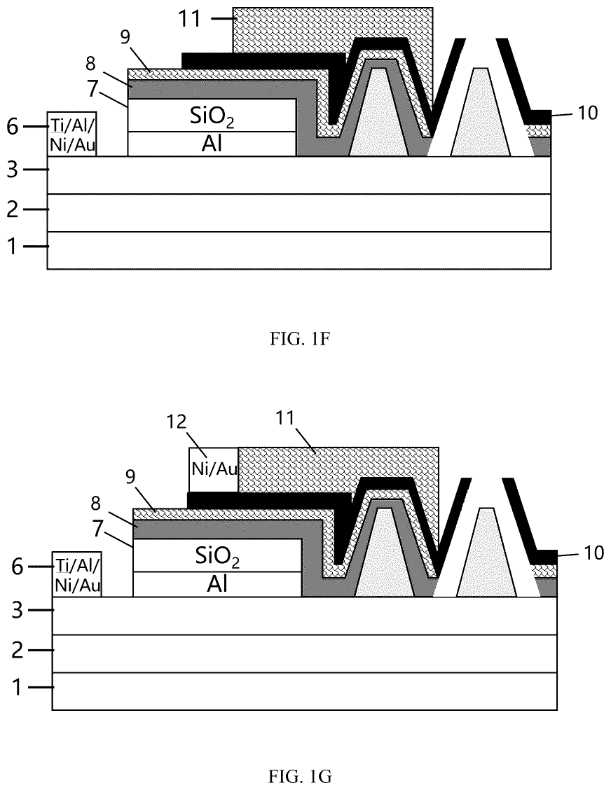

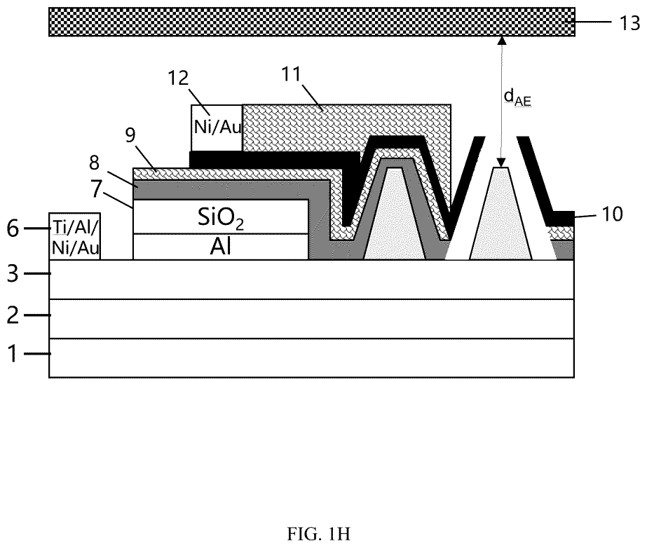

FIG. 1A to FIG. 1H are views of the process of a method for manufacturing a field emitter according to an embodiment of the present disclosure.

Referring to FIG. 1A, in the manufacturing step I, a buffer layer 2 and a primary epitaxial layer 3 which are laminated are sequentially manufactured and formed on a substrate 1. In other embodiments, the buffer layer 2 may be omitted, whereby the primary epitaxial layer 3 may be manufactured directly on the substrate.

Here, the buffer layer 2 may be made of GaN or AlGaN, etc., and the primary epitaxial layer 3 may be made of unintentionally doped GaN (U-GaN) and the like.

Referring to FIG. 1B, in the manufacturing step II, a plurality of secondary epitaxial structures 5 are formed on the primary epitaxial layer 3 with a spacing between the adjacent secondary epitaxial structures 5.

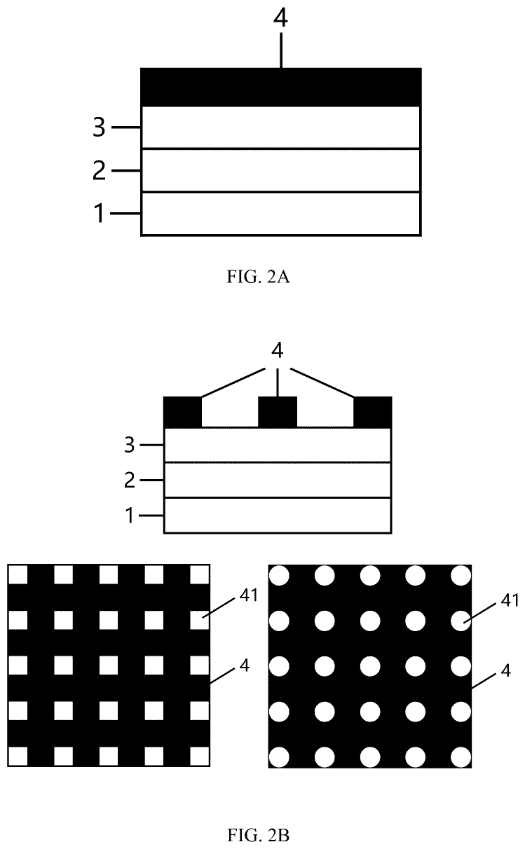

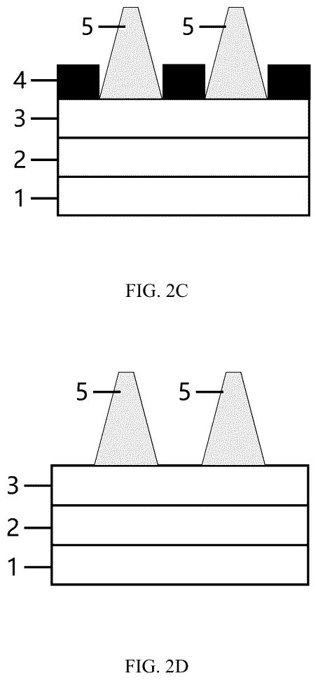

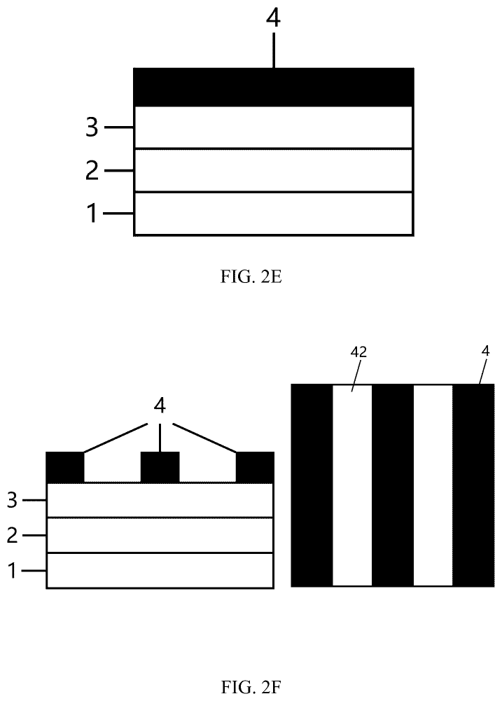

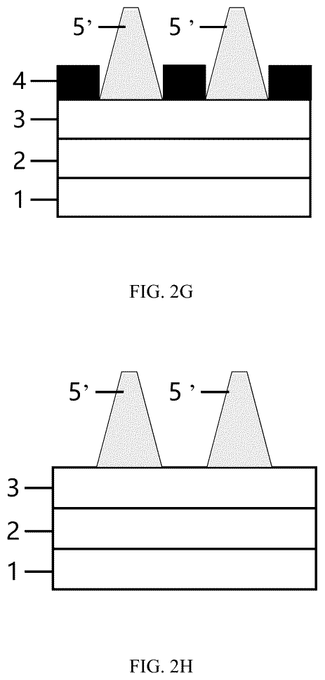

Here, the secondary epitaxial structure 5 may be made of GaN or AlGaN or the like. Further, N-type doping may be performed on the secondary epitaxial structure 5. The specific forming process of the secondary epitaxial structure 5 in this embodiment is described with reference to FIG. 2A to FIG. 2D, and the detail description below.

FIG. 2A to FIG. 2D are views of the process for manufacturing and forming a secondary epitaxial structure according to an embodiment of the present disclosure.

First, referring to FIG. 2A, a mask layer 4 is formed on the primary epitaxial layer 3. Here, the material of the mask layer 4 may be silicon dioxide (SiO₂) or the like.

Next, referring to FIG. 2B, the mask layer 4 is patterned to form a plurality of via holes 41 arranged in an array in the mask layer 4. It is to be noted that the via hole 41 exposes a corresponding part of the primary epitaxial layer 3 below the same. Here, the upper view in FIG. 2B is a side view of the patterned mask layer 4, and the lower left view and the lower right view are top views of the patterned mask layer 4 with two different patterns.

Next, referring to FIG. 2C, secondary epitaxy is performed on the primary epitaxial layer 3 exposed by each of the via holes 41 to form a plurality of secondary epitaxial structures 5.

Finally, referring to FIG. 2D, the remaining mask layer 4 is removed.

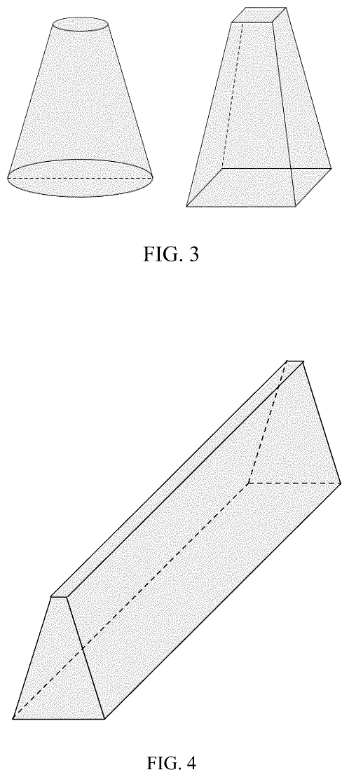

The plurality of secondary epitaxial structures 5 formed by the process of FIG. 2A to FIG. 2D are arranged in an array, the secondary epitaxial structure 5 is a secondary epitaxial protruding block, and the secondary epitaxial protruding block is in a shape of a circular truncated pyramid or a quadrilateral truncated pyramid (see FIG. 3). In this case, the angle between the side face of the secondary epitaxial structure 5 and the plane where the primary epitaxial layer 3 is located may be, for example, between 58° and 60°.

FIG. 2E to FIG. 2H are views of the process for manufacturing and forming a secondary epitaxial structure according to another embodiment of the present disclosure.

First, referring to FIG. 2E, a mask layer 4 is formed on the primary epitaxial layer 3. Here, the material of the mask layer 4 may be silicon dioxide (SiO₂) or the like.

Next, referring to FIG. 2F, the mask layer 4 is patterned to form a plurality of via holes 42 sequentially arranged at intervals in the mask layer 4, the via hole 42 extending in a length direction perpendicular to the direction in which the plurality of via holes 42 are arranged. It is to be noted that the via hole 42 exposes a corresponding part of the primary epitaxial layer 3 below the same. Here, the left view in FIG. 2B is a side view of the patterned mask layer 4, and the right view is a top view of the patterned mask layer 4.

Next, referring to FIG. 2G, secondary epitaxy is performed on the primary epitaxial layer 3 exposed by each of the via holes 41 to form a plurality of secondary epitaxial structures 5′.

Finally, referring to FIG. 2H, the remaining mask layer 4 is removed.

The plurality of secondary epitaxial structures 5′ formed by the process of FIG. 2E to FIG. 2H are sequentially arranged at intervals, the secondary epitaxial structure 5′ is a secondary epitaxial protruding strip, and the secondary epitaxial protruding strip extends in a length direction perpendicular to the direction in which the plurality of secondary epitaxial protruding strips are arranged (see FIG. 4). Further, the cross-sectional shape of the secondary epitaxial protruding strip is an isosceles trapezoid.

It is to be noted that the steps of FIG. 2D and FIG. 2H may be omitted when the material of the mask layer 4 is, for example, aluminum oxide (Al₂O₃). That is, the remaining mask layer 4 may be present, and the specific function will be described below.

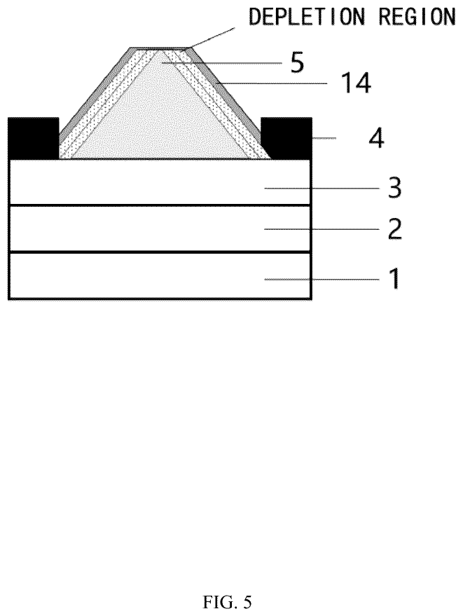

After the manufacturing step II is completed and before the manufacturing step III is performed, the manufacturing method according to the embodiment of the present disclosure may further include: forming a depletion layer 14 on the top surface and the side surface of the secondary epitaxial structure 5 to form a depletion region between the side surface and the depletion layer 14, as shown in FIG. 5. Since the depletion layer 14 may be epitaxial p-GaN, which is thin, and the epitaxy rate of the inclined side surface is much greater than the epitaxy rate of the top surface, the p-GaN thickness of the top surface may be negligible, which has very little effect on device performance. In this way, the depletion region may be obtained on the side surface, the actual size of the top surface is further reduced, and the depletion region formed on the side surface can greatly reduce the leakage current of the device.

In this embodiment, the size of the top surface (width from left to right in the plane of the paper) may be less than 50 nm.

Referring to FIG. 1C, in the manufacturing step III, an emitter electrode layer 6 and a dielectric layer 7 between the emitter electrode layer 6 and the plurality of secondary epitaxial structures 5 are formed on the primary epitaxial layer 3.

Here, the emitter electrode layer 6 may be formed by a Ti/Al/Ni/Au multilayer metal layer, and the dielectric layer 7 may be formed by an aluminum layer and a silicon dioxide layer laminated on the aluminum layer.

Referring to FIG. 1D, in the manufacturing step IV, a protective layer 8, an insulating layer 9, a gate electrode layer 10 and a planarization layer 11 which are laminated are sequentially formed on the dielectric layer 7 and the plurality of secondary epitaxial structures 5.

Here, the protective layer 8 may be made of aluminum oxide. The insulating layer 9 and the planarization layer 11 may be made of tetraethyl orthosilicate (TEOS). The gate electrode layer 10 may be made of metal chromium (Cr).

In another embodiment according to the present disclosure, as described above, the protective layer 8 may be omitted when the material of the mask layer 4 is, for example, aluminum oxide (Al₂O₃). In this case, in the manufacturing step IV, the insulating layer 9, the gate electrode layer 10 and the planarization layer 11 which are stacked are sequentially formed on the dielectric layer 7, the plurality of secondary epitaxial structures 5 and the remaining aluminum oxide layer 4.

Referring to FIG. 1E, in the manufacturing step V, the planarization layer 11 is etched to expose part of the gate electrode layer 10 on the dielectric layer 7 and part of the secondary epitaxial structure 5.

Referring to FIG. 1F, in the manufacturing step VI, the protective layer 8, the insulating layer 9 and the exposed part of the gate electrode layer 10 on part of the secondary epitaxial structure 5 are etched and removed to expose part of the secondary epitaxial structure 5.

Here, in another embodiment according to the present disclosure, as described above, when the material of the mask layer 4 is, for example, aluminum oxide (Al₂O₃), the protective layer 8 may be omitted. In this case, in the manufacturing step VI, the insulating layer 9 and the exposed part of the gate electrode layer 10 on part of the secondary epitaxial structure 5 are etched and removed to expose part of the secondary epitaxial structure 5.

Referring to FIG. 1G, in the manufacturing step VII, a gate connection electrode layer 12 is formed on the exposed gate electrode layer 10 on the dielectric layer 7.

Here, the gate connection electrode layer 12 may be formed by a Ni/Au multilayer metal layer.

Referring to FIG. 1H, in the manufacturing step VIII, an anode 13 opposite to the exposed part of the secondary epitaxial structure 5 is formed, the anode 13 and the exposed part of the secondary epitaxial structure 5 having a predetermined distance from each other. In one example, the predetermined distance d_{AE} is 1-10 mm.

It is to be noted that although the anode 13 is suspended in FIG. 1H, in practice, the anode 13 is supported by a support member. For example, when encapsulation is performed, the anode 13 may be formed on an inner wall capable of being encapsulated placed opposite to the components from the substrate 1 to the gate connection electrode layer 12, so as to place the anode 13 opposite to the secondary epitaxial structure 5.

Yet another embodiment of the present disclosure further provides a field emitter manufactured and formed by the above manufacturing method.

In summary, the field emitter and the method for manufacturing the same according to the embodiments of the present disclosure can provide device performance with a low turn-on voltage and a high gain. Since etching treatment is not required for forming the primary epitaxial layer and the secondary epitaxial structure which are directly formed by epitaxial deposition, the on-chip uniformity of the device is improved, the production efficiency of the device is improved and the reliability of the device is improved.

Specific embodiments of the present disclosure have been described above. Other embodiments are within the scope of the appended claims.

The terms “exemplary”, “example”, and the like, as used throughout this description, mean “serving as an example, instance, or illustration”, and do not mean “preferred” or “having advantageous” over other embodiments. The detailed description includes specific details for the purpose of providing an understanding of the described technology. However, the techniques may be implemented without these specific details. In some instances, well-known structures and devices are shown in the form of a block diagram in order to avoid obscuring the concepts of the described embodiments.

Although optional modes of implementation of the embodiments of the present disclosure have been described above in detail with reference to the accompanying drawings, it is to be understood that the embodiments of the present disclosure are not limited to the specific details in the modes of implementation described above, and that various simple modifications may be made on the technical solution of the embodiment of the present disclosure within the technical conception and scope of the embodiments of the present disclosure, and these simple modifications all fall within the protection scope of the embodiment of the present disclosure.

The above description of the content of the description is provided to enable any person skilled in the art to realize or use the content of the description. Various modifications made to the content of the description will be readily apparent to those skilled in the art, and the generic principles defined herein may be applied to other variations without departing from the protection scope of the content of the description. Thus, the content of the description is not limited to the example and design described herein, but is consistent with the broadest range of the principles and novelty features consistent with the present disclosure herein.

1. A method for manufacturing a field emitter, comprising:
forming a primary epitaxial layer on a substrate;
forming a plurality of secondary epitaxial structures on the primary epitaxial layer with a spacing between the adjacent secondary epitaxial structures;
forming an emitter electrode layer and a dielectric layer between the emitter electrode layer and the plurality of secondary epitaxial structures on the primary epitaxial layer;
sequentially forming a protective layer, an insulating layer, a gate electrode layer and a planarization layer which are laminated on the dielectric layer and the plurality of secondary epitaxial structures;
etching the planarization layer to expose part of the gate electrode layer on the dielectric layer and part of the secondary epitaxial structure;
etching and removing the protective layer, the insulating layer and the exposed part of the gate electrode layer on part of the secondary epitaxial structure so as to expose part of the secondary epitaxial structure;
forming a gate connection electrode layer on the exposed gate electrode layer on the dielectric layer; and
forming an anode opposite to the exposed part of the secondary epitaxial structure, the anode and the exposed part of the secondary epitaxial structure having a predetermined distance from each other.

2. The manufacturing method according to claim 1, wherein the plurality of secondary epitaxial structures are arranged in an array, the secondary epitaxial structure is a secondary epitaxial protruding block, and the secondary epitaxial protruding block is in a shape of a circular truncated pyramid or a quadrilateral truncated pyramid.

3. The manufacturing method according to claim 1, wherein the plurality of secondary epitaxial structures are sequentially arranged at intervals, the secondary epitaxial structure is a secondary epitaxial protruding rib, and the secondary epitaxial protruding rib extends in a length direction perpendicular to the direction in which the plurality of secondary epitaxial protruding ribs are arranged.

4. The manufacturing method according to claim 1, wherein the predetermined distance is 1-10 mm.

5. The manufacturing method according to claim 1, further comprising: before forming an emitter electrode layer and a dielectric layer between the emitter electrode layer and the plurality of secondary epitaxial structures on the primary epitaxial layer,
forming a depletion layer on the top surface and the side surface of the secondary epitaxial structure to form a depletion region between the side surface and the depletion layer.

6. The manufacturing method according to claim 1, further comprising: before forming a primary epitaxial layer on a substrate;
forming a buffer layer on the substrate, the epitaxial layer being formed on the buffer layer.

7. The manufacturing method according to claim 1, wherein the method for forming a plurality of secondary epitaxial structures on the primary epitaxial layer specifically comprises:
forming a mask layer on the primary epitaxial layer;
patterning the mask layer to form a plurality of via holes arranged in an array in the mask layer;
performing secondary epitaxy on the primary epitaxial layer exposed by each of the via holes to form a plurality of secondary epitaxial structures; and
removing the remaining mask layer.

8. The manufacturing method according to claim 2, wherein the method for forming a plurality of secondary epitaxial structures on the primary epitaxial layer specifically comprises:
forming a mask layer on the primary epitaxial layer;
patterning the mask layer to form a plurality of via holes arranged in an array in the mask layer;
performing secondary epitaxy on the primary epitaxial layer exposed by each of the via holes to form a plurality of secondary epitaxial structures; and
removing the remaining mask layer.

9. The manufacturing method according to claim 1, wherein the method for forming a plurality of secondary epitaxial structures on the primary epitaxial layer specifically comprises:
forming a mask layer on the primary epitaxial layer;
patterning the mask layer to form a plurality of via holes arranged sequentially at intervals in the mask layer, the via hole extending in a length direction perpendicular to the direction in which the plurality of via holes are arranged;
performing secondary epitaxy on the primary epitaxial layer exposed by each of the via holes to form a plurality of secondary epitaxial structures; and
removing the remaining mask layer.

10. The manufacturing method according to claim 3, wherein the method for forming a plurality of secondary epitaxial structures on the primary epitaxial layer specifically comprises:
forming a mask layer on the primary epitaxial layer;
patterning the mask layer to form a plurality of via holes arranged sequentially at intervals in the mask layer, the via hole extending in a length direction perpendicular to the direction in which the plurality of via holes are arranged;
performing secondary epitaxy on the primary epitaxial layer exposed by each of the via holes to form a plurality of secondary epitaxial structures; and
removing the remaining mask layer.

11. A method for manufacturing a field emitter, comprising:
sequentially forming a primary epitaxial layer and an aluminum oxide layer which are laminated on a substrate;
patterning the aluminum oxide layer to form a plurality of via holes;
forming a plurality of secondary epitaxial structures on the primary epitaxial layer exposed by the via hole;
forming an emitter electrode layer and a dielectric layer between the emitter electrode layer and the plurality of secondary epitaxial structures on the primary epitaxial layer;
sequentially forming an insulating layer, a gate electrode layer and a planarization layer which are laminated on the dielectric layer, the plurality of secondary epitaxial structures and the remaining aluminum oxide layer;
etching the planarization layer to expose part of the gate electrode layer on the dielectric layer and part of the secondary epitaxial structure;
etching and removing the insulating layer and the exposed part of the gate electrode layer on part of the secondary epitaxial structure so as to expose part of the secondary epitaxial structure;
forming a gate connection electrode layer on the exposed gate electrode layer on the dielectric layer; and
forming an anode opposite to the exposed part of the secondary epitaxial structure, the anode and the exposed part of the secondary epitaxial structure having a predetermined distance from each other.

12. A field emitter manufactured with the manufacturing method according to claim 1.
